(19) United States
(12) Patent Application Publication
(10) Pub. No.: US 2014/0101943 A1
(43) Pub. Date: Apr. 17, 2014

(54) RETRACTABLE KNIFE WITH A MULTISTAGE POSITIONING FUNCTION

(71) Applicant: Jitung CHU, New Taipei City (TW)

(72) Inventor: Jitung CHU, New Taipei City (TW)

(21) Appl. No.: 13/653,578

(22) Filed: Oct. 17, 2012

(51) Int. Cl. B26B 1/08

(52) U.S. Cl. CPC B26B 1/08
USPC 30/162

(57) ABSTRACT

A retractable knife with a multistage positioning function has a handle, a blade slidably mounted in the handle, and an operating assembly connected to the handle and the blade. The handle has a guiding panel with a guiding hole and multiple pairs of positioning recesses formed in an inner sidewall defined around the guiding hole. The operating assembly has a guiding rod with a positioning head selectively engaging between one of the pairs of the positioning recesses. The blade is capable of protruding out of the handle with a multistage function for the convenience of using the knife. Since a resilient element pushes the guiding rod to allow the positioning head to abut the guiding panel, the blade does not easily slide out of the handle, so the knife can be used safely.

### BACKGROUND OF THE INVENTION

1. Field of the Invention

The present invention relates to a knife, especially to a retractable knife that has a multistage positioning function and can be used safely.

2. Description of the Prior Art(s)

A conventional retractable knife has a handle, a blade, a resilient element, a switch and an operating button. The blade is slidably mounted in the handle. The resilient element is mounted in the handle and has two opposite ends respectively abutting the handle and an inner end of the blade. The switch is connected to the handle and the blade. The operating button is connected to the switch. When the operating button is pressed, the switch disengages from the handle. The resilient element pushes the blade to move toward a front open end of the handle. As the blade extends out of the handle or is retracted in the handle, the switch locks and holds the blade to prevent the blade from arbitrarily retracted into the handle or extending out of the handle.

However, in some conditions, such as working on a finely cutting work, if only part of the blade is extended out of the handle, the knife would be operated stably. Although the resilient element pushes the blade from a rear closed end toward the front open end of the handle, the blade of the conventional retractable knife is unable to be held between the rear closed end and the front open end of the handle to allow part of the blade to protrude out of the blade for the convenience of operating the conventional knife. Moreover, the conventional has complicated structures and numerous operating processes and is not well designed.

To overcome the shortcomings, the present invention provides a retractable knife with a multistage positioning function to mitigate or obviate the aforementioned problems.

### SUMMARY OF THE INVENTION

The main objective of the present invention is to provide a retractable knife with a multistage positioning function. The knife has a handle, a blade slidably mounted in the handle, and an operating assembly connected to the handle and the blade. The handle has a guiding panel with a guiding hole and multiple pairs of positioning recesses formed in an inner sidewall defined around the guiding hole. Each pair of the positioning recesses has two positioning recesses corresponding to each other. The operating assembly has a guiding rod with a positioning head selectively engaging between one of the pairs of the positioning recesses.

The blade is capable of protruding out of the handle with a multistage function for the convenience of using the knife. Moreover, since a resilient element pushes the guiding rod to allow the positioning head to abut the guiding panel, the blade does not easily slide out of the handle no matter a pressing button of the operating assembly is accidentally touched, the knife is tossed or gravity is applied on the knife. The knife can be used safely.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a retractable knife with a multistage positioning function in accordance with the present invention;

FIG. 2 is an exploded perspective view of the retractable knife in FIG. 1;

FIG. 3 is a cross-sectional side view of the retractable knife in FIG. 1;

FIG. 4 is an enlarged top view of a guiding panel of the retractable knife in FIG. 1;

FIG. 5 is a cross-sectional end view of the retractable knife in FIG. 1;

FIG. 6 is an operational cross-sectional end view of the retractable knife in FIG. 1;

FIG. 7 is a partial operational top view of the retractable knife in FIG. 1; and

FIG. 8 is another partial operational top view of the retractable knife in FIG. 1.

### DETAILED DESCRIPTION OF THE PREFERRED EMBODIMENTS

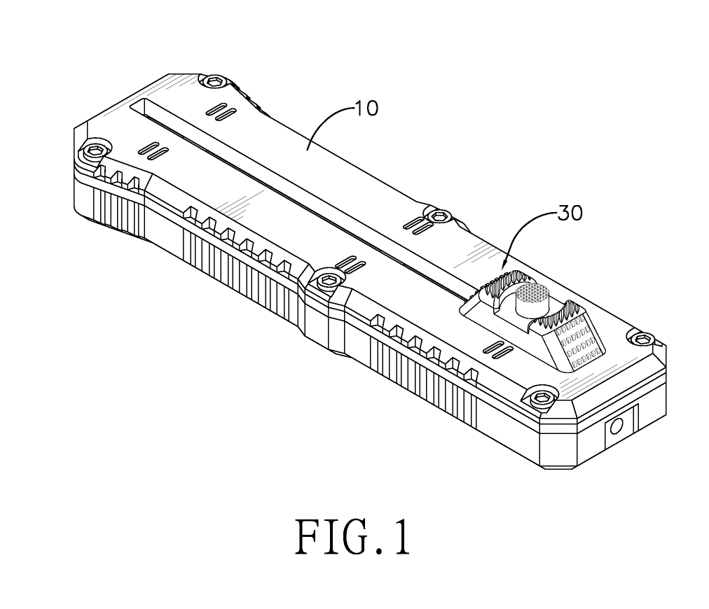

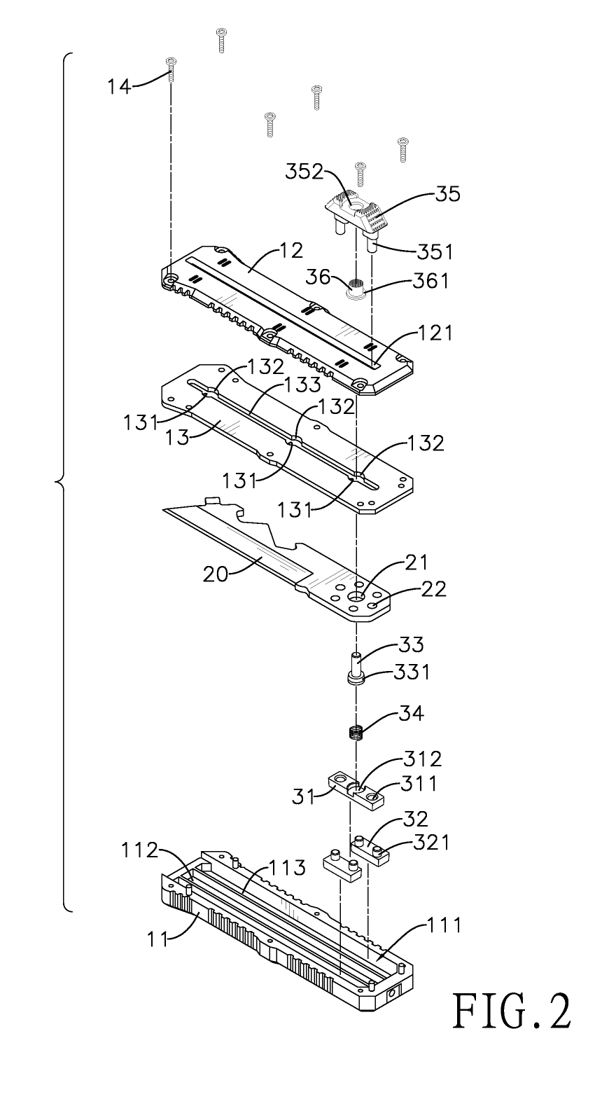

With reference to FIGS. 1 and 2, a retractable knife with a multistage positioning function in accordance with the present invention comprises a handle 10, a blade 20 and an operating assembly 30.

The handle 10 has a casing 11, a cover panel 12 and a guiding panel 13.

The casing 11 has an upper surface, a front end, a rear end, a blade recess 111, an inner bottom surface, an inner guiding groove 112 and at least one sliding groove 113. The blade recess 111 is formed in the upper surface of the casing 11, axially extends along the casing 11 and is formed through the front end of the casing 11. The inner bottom surface of the casing 11 is defined in the blade recess 111. The inner guiding groove 112 is elongated, is formed in the inner bottom surface of the casing 11 and has two opposite ends respectively extending toward the front end of the casing 11 and the rear end of the casing 11. The at least one sliding groove 113 is formed in the inner bottom surface of the casing 11 and extends parallel to the inner guiding groove 112.

The cover panel 12 is securely mounted on the upper surface of the casing 11 and has an outer surface, two opposite ends and an outer guiding hole 121. The outer guiding hole 121 is elongated, is formed through the cover panel 12 and has two opposite ends respectively extending toward the ends of the cover panel 12.

The guiding panel 13 is securely held between the casing 11 and the cover panel 12 and has two opposite ends, a guiding hole 133, an inner sidewall, multiple first positioning recesses 131 and multiple second positioning recesses 132. The guiding hole 133 is elongated, is formed through the guiding panel 13, corresponds to the inner guiding groove 112 of the casing 11 and the outer guiding hole 121 of the cover panel 12 and has two opposite ends respectively extending toward the ends of the guiding panel 13. The inner sidewall of the guiding panel 13 is defined around the guiding hole 133 of the guiding panel 13. The first positioning recesses 131 are separately formed in the inner sidewall of the guiding panel 13. The second positioning recesses 132 are separately formed in the inner sidewall of the guiding panel 13 and respectively correspond to the first positioning recesses 131. Specifically, multiple fasteners 14 are mounted through the casing 11, the cover panel 12 and the guiding panel 13 and securely hold the casing 11, the cover panel 12 and the guiding panel 13 together.

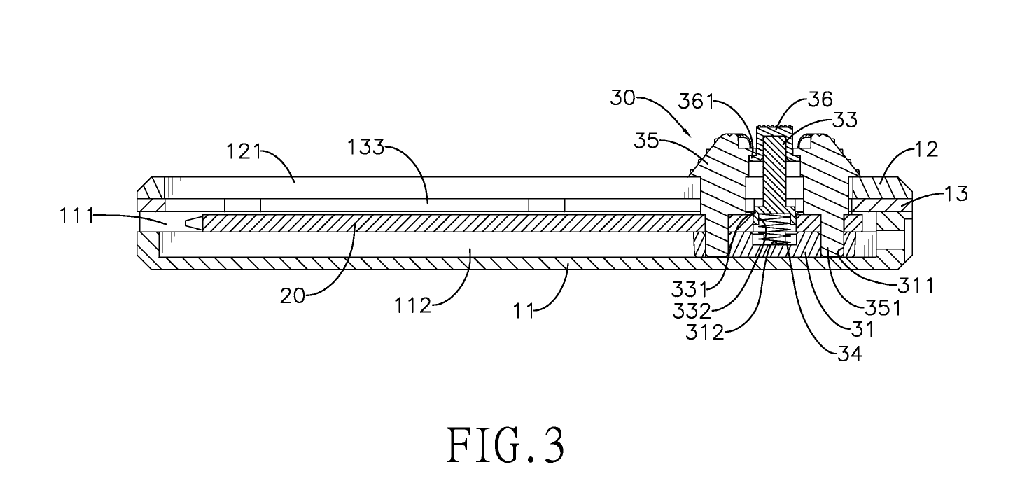

With further reference to FIG. 3, the blade 20 is slidably mounted in the blade recess 111 of the casing 11 and has an inner end, a through hole 21 and multiple alignment holes 22. The inner end of the blade 20 is mounted in the blade recess 111 of the casing 11. The through hole 21 of the blade 20 is formed through the blade 20, is disposed adjacent to the inner end of the blade 20 and corresponds to the inner guiding groove 112 of the casing 11. The alignment holes 22 of the blade 20 are separately formed through the blade 20 and are arranged around the through hole 21 of the blade 20.

The operating assembly 30 is slidably mounted on the handle 10 and has a main slider 31, at least one additional slider 32, a guiding rod 33, a resilient element 34, a pushing button 35 and a pressing button 36.

The main slider 31 is slidably mounted in the inner guiding groove 112 of the casing 11 and has an upper surface, two engaging holes 311 and a mounting recess 312. The engaging holes 311 are separately formed in the upper surface of the main slider 31. The mounting recess 312 of the main slider 31 is formed in the upper surface of the main slider 31 and is disposed between the engaging holes 311.

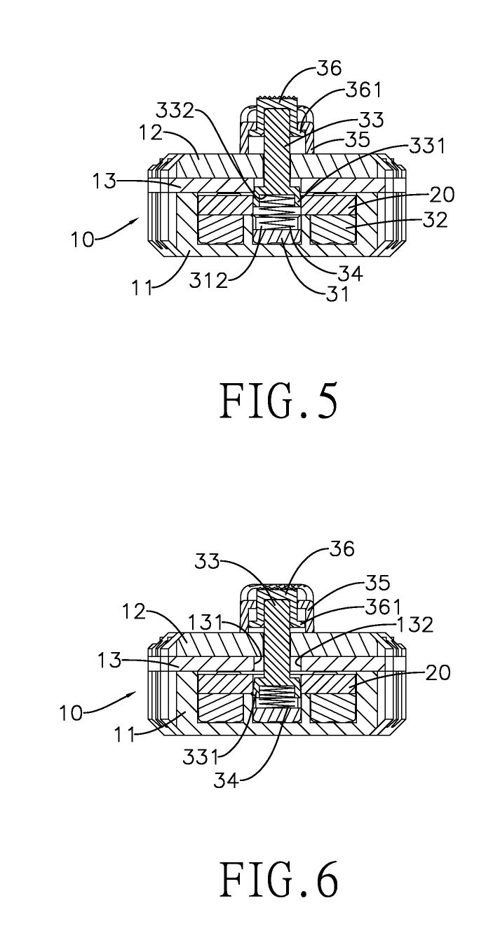

With further reference to FIG. 5, the at least one additional slider 32 is slidably mounted in the at least one sliding groove 113 of the casing 11 and is attached to the blade 20. Each one of the at least one additional slider 32 has an upper surface and at least one alignment protrusion 321. The at least one alignment protrusion 321 protrudes up from the upper surface of the additional slider 32. Each one of the at least one alignment protrusion 321 of the additional slider 32 engages a corresponding alignment hole 22 of the blade 20.

The guiding rod 33 is mounted through the through hole 21 of the blade 20, the guiding hole 133 of the guiding panel 13 and the guiding hole 121 of the cover panel 12, and has a lower end, a top end, a positioning head 331 and a mounting recess 332. The positioning head 331 is formed on the lower end of the guiding rod 33, tapers inward from a distal end surface of the positioning head 331 to the lower end of the guiding rod 33, selectively engages between one of the first positioning recesses 131 and one of the second positioning recesses 132 that correspond to each other, and has an outer surface being cambered. The mounting recess 332 of the guiding rod 33 is formed in the distal end surface of the positioning head 331 of the guiding rod 33.

The resilient element 34 is mounted between the main slider 31 and the guiding rod 33, is mounted in the mounting recess 312 of the main slider 31 and the mounting recess 332 of the guiding rod 33 and has two opposite ends respectively abutting the main slider 31 and the guiding rod 33.

The pushing button 35 is mounted on the outer surface of the cover panel 12, is mounted through the outer guiding hole 121 of the cover panel 12 and the guiding hole 133 of the guiding panel 13, is securely attached to the blade 20, and has a lower surface, two alignment protrusions 351, a through hole 352 and an inner sidewall. The alignment protrusions 351 of the pushing button 35 separately protrude down from the lower surface of the pushing button 35, are mounted through the outer guiding hole 121 of the cover panel 12, the guiding hole 133 of the guiding panel 13 and the alignment holes 22 of the blade 20, and respectively engage the engaging holes 311 of the main slider 31. The through hole 352 of the pushing button 35 is formed through the pushing button 35 and is disposed between the alignment protrusions 351 of the pushing button 35. The inner sidewall of the pushing button 35 is defined around the through hole 352 of the pushing button 35.

The pressing button 36 is mounted on and around the top end of the guiding rod 33, is slidably mounted through the through hole 352 of the pushing button 35 and has an outer surface and a flange 361. The flange 361 is formed around the outer surface of the pressing button 36 and selectively abuts against the inner sidewall of the pushing button 35.

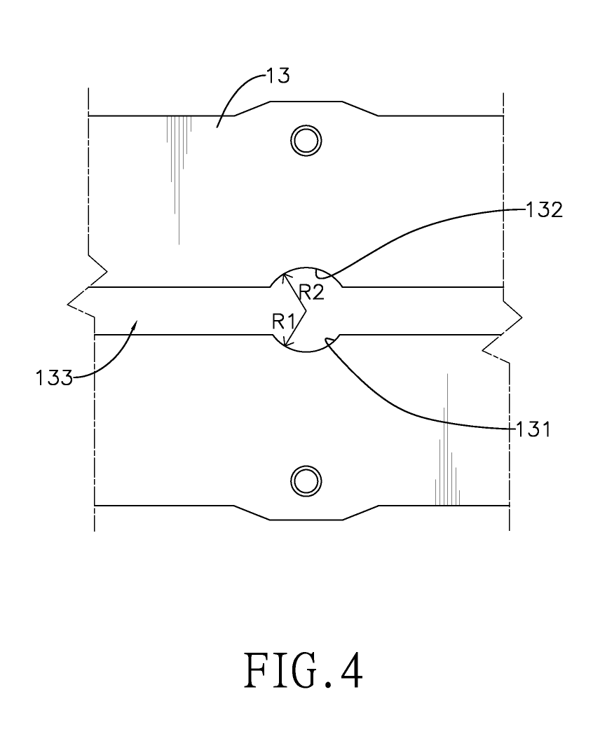

With further reference to FIG. 4, preferably, each first positioning recess 131 of the guiding panel 13 is arc and has a first radius of curvature R1. Each second positioning recess 132 of the guiding panel 13 is arc and has a second radius of curvature R2 being larger than the first radius of curvatures R1 of the first positioning recesses 131. The outer surface of the positioning head 331 of the guiding rod 33 has a limiting radius of curvature. The limiting radius of curvature is defined adjacent to the distal end surface of the positioning head 331, is larger than the first radius of curvatures R1 of the first positioning recesses 131 of the guiding panel 13 and is smaller than the second radius of curvatures R2 of the second positioning recesses 132 of the guiding panel 13. Thus, when the positioning head 331 of the guiding rod 33 engages between one of the first positioning recesses 131 and one of the second positioning recesses 132 that correspond to each other, the positioning head 331 tilts, one part of the positioning head 331 get stuck in the first positioning recess 131 and the other part of the positioning head 331 is capable of being mounted through the second positioning recess 132. The guiding rod 33 does not swing and pivot on the positioning head 331.

With reference to FIGS. 3 and 5, the resilient element 34 pushes the positioning head 331 of the guiding rod 33 and the positioning head 331 engages between the first positioning recess 131 and the second positioning recess 132 that are disposed most adjacent to rear end of the casing 11. Therefore, the blade 20 is fully and stably retracted in the handle 10.

With further reference to FIG. 6, when the pressing button 36 as well as the guiding rod 33 is pushed to press against the resilient element 34, the positioning head 331 of the guiding rod 33 disengages from the first positioning recess 131 and the second positioning recess 132. Then, as the pushing button 35 is pushed forward, the operating assembly 30 and the blade 20 move along the guiding hole 133 of the guiding panel 13, the inner guiding groove 112 of the casing 11 and the outer guiding hole 121 of the cover panel 12.

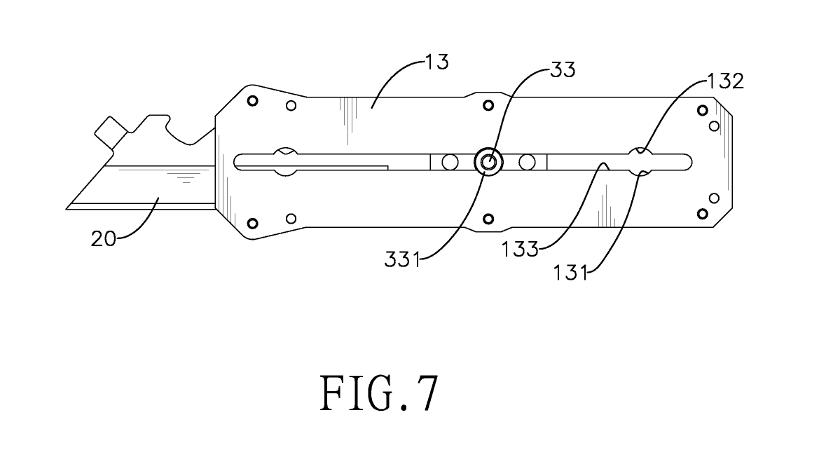

With further reference to FIG. 7, the operating assembly 30 and the inner end of the blade 20 are moved to a middle of the handle 10 to allow a front half of the blade 20 to protrude out of the handle 10. When the pressing button 36 is released, the resilient element 34 pushes the guiding rod 33 to allow the positioning head 331 of the guiding rod 33 to engage between the first positioning recess 131 and the second positioning recess 132 that are disposed at the middle of the handle 10. Thus, the knife of the present invention is stably kept in a status of having a part of the blade 20 protruding out of the handle 10.

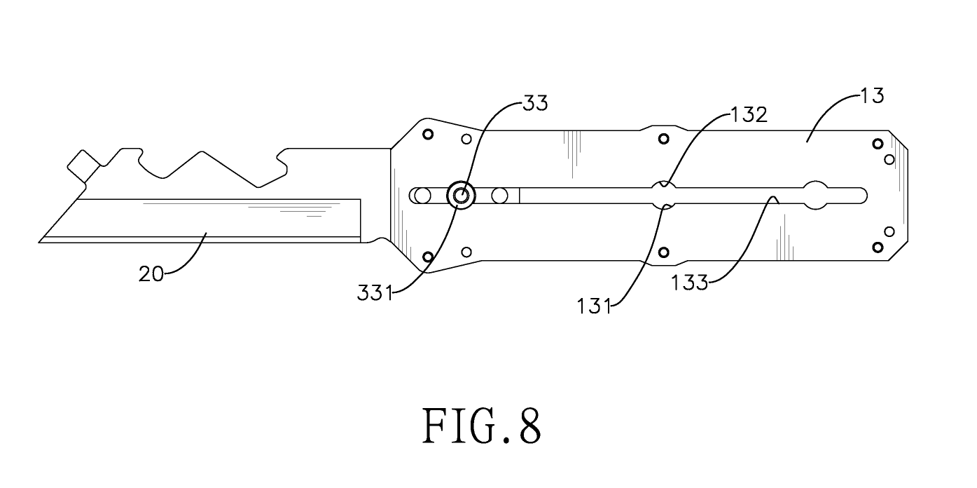

With reference to FIG. 8, when the pressing button 36 is pushed again, the operating assembly 30 and the blade 20 are moved toward the front end of the casing 11, and the positioning head 331 of the guiding rod 33 securely engage between the first positioning recess 131 and the second positioning recess 132 that are disposed most adjacent to the front end of the casing 11, the knife of the present invention is stably kept in a status of having the blade 20 fully protruding out of the handle 10.

The retractable knife with the multistage positioning function as described has the following advantages. The blade 20 is capable of protruding out of the handle 10 with the multistage function for the convenience of using the knife. Moreover, since a resilient element 34 pushes the guiding rod 33 to allow the positioning head 331 to abut the guiding panel 13, the blade 20 does not easily slide out of the handle 10 no matter the pressing button 36 of the operating assembly 30 is accidentally touched, the knife is tossed or gravity is applied on the knife. The knife can be used safely.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A retractable knife with a multistage positioning function comprising
a handle having
a casing having
an upper surface;
a front end;
a blade recess formed in the upper surface of the casing, axially extending along the casing and formed through the front end of the casing;
an inner bottom surface defined in the blade recess; and
an inner guiding groove formed in the inner bottom surface of the casing;
a cover panel securely mounted on the upper surface of the casing, and having an outer surface, two opposite ends and an outer guiding hole formed through the cover panel; and
a guiding panel securely held between the casing and the cover panel and having
a guiding hole formed through the guiding panel, corresponding to the inner guiding groove of the casing and the outer guiding hole of the cover panel;
an inner sidewall defined around the guiding hole of the guiding panel;
multiple first positioning recesses separately formed in the inner sidewall of the guiding panel; and
multiple second positioning recesses separately formed in the inner sidewall of the guiding panel and respectively corresponding to the first positioning recesses;
a blade slidably mounted in the blade recess of the casing and having an inner end and a through hole formed through the blade, disposed adjacent to the inner end of the blade, and corresponding to the inner guiding groove of the casing; and
an operating assembly slidably mounted on the handle and having
a main slider slidably mounted in the inner guiding groove of the casing;
a guiding rod mounted through the through hole of the blade, the guiding hole of the guiding panel and the guiding hole of the cover panel, and having a lower end, a top end; and a positioning head formed on the lower end of the guiding rod and selectively engaging between one of the first positioning recesses and one of the second positioning recesses that correspond to each other;
a resilient element mounted between the main slider and the guiding rod and having two opposite ends respectively abutting the main slider and the guiding rod;
a pushing button mounted on the outer surface of the cover panel, mounted through the outer guiding hole of the cover panel and the guiding hole of the guiding panel, securely attached to the blade, and having a through hole formed through the pushing button; and
a pressing button mounted on and around the top end of the guiding rod, slidably mounted through the through hole of the pushing button.

2. The knife as claimed in claim 1, wherein
the casing of the handle further has at least one sliding groove formed in the inner bottom surface of the casing and extending parallel to the inner guiding groove; and
the operating assembly further has at least one additional slider slidably mounted in the at least one sliding groove of the casing and attached to the blade.

3. The knife as claimed in claim 2, wherein
the blade further has multiple alignment holes separately formed through the blade and arranged around the through hole of the blade;
the main slider has an upper surface and two engaging holes separately formed in the upper surface of the main slider;
each one of the at least one additional slider has an upper surface and at least one alignment protrusion protruding up from the upper surface of the additional slider, and each one of the at least one alignment protrusion of the additional slider engaging a corresponding alignment hole of the blade; and
the pushing button further has a lower surface and two alignment protrusions separately protruding down from the lower surface of the pushing button, mounted through the outer guiding hole of the cover panel, the guiding hole of the guiding panel and the alignment holes of the blade, and respectively engaging the engaging holes of the main slider.

4. The knife as claimed in claim 1, wherein
the main slider further has a mounting recess formed in the upper surface of the main slider;
the guiding rod further has a mounting recess formed in a distal end surface of the positioning head of the guiding rod; and
the resilient element is mounted in the mounting recess of the main slider and the mounting recess of the guiding rod.

5. The knife as claimed in claim 2, wherein
the main slider further has a mounting recess formed in the upper surface of the main slider;
the guiding rod further has a mounting recess formed in a distal end surface of the positioning head of the guiding rod; and
the resilient element is mounted in the mounting recess of the main slider and the mounting recess of the guiding rod.

6. The knife as claimed in claim 3, wherein
the main slider further has a mounting recess formed in the upper surface of the main slider;
the guiding rod further has a mounting recess formed in a distal end surface of the positioning head of the guiding rod; and
the resilient element is mounted in the mounting recess of the main slider and the mounting recess of the guiding rod.

7. The knife as claimed in claim 1, wherein
each first positioning recess of the guiding panel has a first radius of curvature;
each second positioning recess of the guiding panel has a second radius of curvature being larger than the first radius of curvature of the first positioning recess; and
the positioning head of the guiding rod has an outer surface having a limiting radius of curvature defined adjacent to the distal end surface of the positioning head, being larger than the first radius of curvatures of the first positioning recesses of the guiding panel and being smaller than the second radius of curvatures of the second positioning recesses of the guiding panel.

8. The knife as claimed in claim 2, wherein
each first positioning recess of the guiding panel has a first radius of curvature;
each second positioning recess of the guiding panel has a second radius of curvature being larger than the first radius of curvature of the first positioning recess; and
the positioning head of the guiding rod has an outer surface having a limiting radius of curvature defined adjacent to the distal end surface of the positioning head, being larger than the first radius of curvatures of the first positioning recesses of the guiding panel and being smaller than the second radius of curvatures of the second positioning recesses of the guiding panel.

9. The knife as claimed in claim 3, wherein
each first positioning recess of the guiding panel has a first radius of curvature;
each second positioning recess of the guiding panel has a second radius of curvature being larger than the first radius of curvature of the first positioning recess; and
the positioning head of the guiding rod has an outer surface having a limiting radius of curvature defined adjacent to the distal end surface of the positioning head, being larger than the first radius of curvatures of the first positioning recesses of the guiding panel and being smaller than the second radius of curvatures of the second positioning recesses of the guiding panel.

10. The knife as claimed in claim 4, wherein
each first positioning recess of the guiding panel has a first radius of curvature;
each second positioning recess of the guiding panel has a second radius of curvature being larger than the first radius of curvature of the first positioning recess; and
the positioning head of the guiding rod has an outer surface having a limiting radius of curvature defined adjacent to the distal end surface of the positioning head, being larger than the first radius of curvatures of the first positioning recesses of the guiding panel and being smaller than the second radius of curvatures of the second positioning recesses of the guiding panel.

11. The knife as claimed in claim 5, wherein
each first positioning recess of the guiding panel has a first radius of curvature;
each second positioning recess of the guiding panel has a second radius of curvature being larger than the first radius of curvature of the first positioning recess; and
the positioning head of the guiding rod has an outer surface having a limiting radius of curvature defined adjacent to the distal end surface of the positioning head, being larger than the first radius of curvatures of the first positioning recesses of the guiding panel and being smaller than the second radius of curvatures of the second positioning recesses of the guiding panel.

12. The knife as claimed in claim 6, wherein
each first positioning recess of the guiding panel has a first radius of curvature;
each second positioning recess of the guiding panel has a second radius of curvature being larger than the first radius of curvature of the first positioning recess; and
the positioning head of the guiding rod has an outer surface having a limiting radius of curvature defined adjacent to the distal end surface of the positioning head, being larger than the first radius of curvatures of the first positioning recesses of the guiding panel and being smaller than the second radius of curvatures of the second positioning recesses of the guiding panel.

13. The knife as claimed in claim 10, wherein the positioning head of the guiding rod tapering inward from the distal end surface of the positioning head to the lower end of the guiding rod.

14. The knife as claimed in claim 11, wherein the positioning head of the guiding rod tapering inward from the distal end surface of the positioning head to the lower end of the guiding rod.

15. The knife as claimed in claim 12, wherein the positioning head of the guiding rod tapering inward from the distal end surface of the positioning head to the lower end of the guiding rod.
